(19) United States
(12) Patent Application Publication
(10) Pub. No.: US 2014/0199565 A1
(43) Pub. Date: Jul. 17, 2014

(54) VALVE ASSEMBLY FOR PREVENTING BACKFLOW FOR USE WITH A BATTERY CASE AND BATTERY CASE HAVING THE VALVE ASSEMBLY

(71) Applicant: Samsung SDI Co., Ltd., Yongin-si (KR)

(72) Inventors: Jun-Ho LEE, Yongin-si (KR); Sang-Kyu AHN, Yongin-si (KR)

(73) Assignee: Samsung SDI Co., Ltd., Yongin-si (KR)

(21) Appl. No.: 14/052,522

(22) Filed: Oct. 11, 2013

(30) Foreign Application Priority Data
Jan. 11, 2013 (KR) 10-2013-0003496

(51) Int. Cl. H01M 2/12; F16K 15/02; F16K 17/10

(52) U.S. Cl. CPC H01M 2/1223; F16K 17/10; F16K 15/026
USPC 429/53; 137/512.3; 137/537

(57) ABSTRACT

A valve assembly for preventing backflow and a battery case using the same is disclosed. In one aspect, the valve assembly for preventing backflow includes a first valve; a connection tube connected to the first valve and having at least one bent portion; and a second valve connected to the connection tube. In the valve assembly, the second valve is disposed so that the lowermost surface of the second valve is positioned lower than the lowermost surface of the first valve.

### CROSS-REFERENCE TO RELATED APPLICATIONS

This application claims priority to and the benefit of Korean Patent Application No. 10-2013-0003496, filed on Jan. 11, 2013, in the Korean Intellectual Property Office, the entire content of which is incorporated herein by reference.

### BACKGROUND

1. Field

The disclosed technology relates to a valve assembly for preventing backflow for use with a battery case and the battery case having the same, and more particularly, to a valve assembly for preventing backflow of a fluid that is discharged from a battery case.

2. Description of the Related Technology

In general, a discharge valve for preventing backflow has a structure in which the valve is opened when the fluid pressure inside the battery case reaches a certain threshold, and is closed when the pressure is reduced below the threshold.

In such a valve, when the valve is closed while the pressure is being reduced while the valve is submerged, fluid will frequently flow backwards.

### SUMMARY OF CERTAIN INVENTIVE ASPECTS

Embodiments provide a valve for preventing backflow and a case of a battery comprising the same, which can prevent the backflow of a fluid by changing the position and shape of a valve outlet through which the fluid is discharged.

According to an aspect of the disclosed technology, a valve assembly for preventing backflow and use with a battery case, the valve assembly comprises a first valve; a connection tube connected to the first valve and having at least one bent portion; and a second valve connected to the connection tube, wherein the second valve is disposed so that the lowermost surface of the second valve is positioned lower than the lowermost surface of the first valve so as to discharge fluid from a battery case.

The first valve includes a first valve main body, a coupling provided at one end portion of the first valve main body so as to be coupled to a main body of the battery case, and an outlet provided at the other end portion having a direction opposite to that of the one end portion so as to discharge a first fluid from the main body.

The first valve has a sealing portion between the coupling and the outlet, and form a flow path of a second fluid that is another fluid in the fluid discharged from the case main body.

The connection tube includes a first fastener coupled to the first valve, a connection tube main body connected to the first fastener so as to form the flow path of the second fluid, and a second fastener connecting the connection tube main body and the second valve.

The connection tube main body has an elbow or “U” shape forming a predetermined angle with the first valve.

The second valve includes a second valve main body having one end portion fastened to the second fastener, and a check valve provided at the other end portion of the second valve main body, which has a direction opposite to that of the one end portion.

The check valve is opened to the outside of the battery case so as to block the second fluid from flowing backwards in the direction of the connection tube.

According to another aspect of the disclosed technology, there is provided a battery case, comprises a main body accommodating a battery pack therein; and a valve assembly for preventing backflow, connected to the main body so as to discharge a fluid from the main body, wherein the valve assembly comprises a first valve; a connection tube connected to the first valve and having at least one bent portion; and a second valve connected to the connection tube, wherein the second valve is disposed so that the lowermost surface of the second valve is positioned lower than the lowermost surface of the first valve.

The first valve includes a first valve main body, a coupling provided at one end portion of the first valve main body so as to be coupled to the case main body, and an outlet provided at the other end portion having a direction opposite to that of the one end portion so as to discharge a first fluid from the battery case.

The first valve has a sealing portion between the coupling and the outlet, and forms a flow path of a second fluid that is another fluid in the fluid discharged from the case main body.

The connection tube includes a first fastener coupled to the first valve, a connection tube main body connected to the first fastener so as to form the flow path of the second fluid, and a second fastener connecting the connection tube main body and the second valve.

The connection tube main body has an elbow or “U” shape forming a predetermined angle with the first valve.

The second valve includes a second valve main body having one end portion fastened to the second fastener, and a check valve provided at the other end portion of the second valve main body, which has a direction opposite to that of the one end portion.

The check valve opens to the outside of the battery case so as to block the second fluid from flowing backwards in the direction of the connection tube.

The battery case further comprises a door that opens/closes mounted on the main body; and a door sealing member forming a watertight seal between the main body and the door.

The battery case further comprises a top cover fastened to the case main body; and a top cover sealing member forming a watertight seal between the main body and the top cover.

In embodiments the valve assembly for preventing backflow according to the disclosed technology, it is possible to prevent the back flow of a fluid by changing the position and shape of a valve through which the fluid is discharged.

Accordingly, the usefulness of the valve assembly is maintained even when submerged, and thus it can be applied to a case of a large-capacity battery.

### BRIEF DESCRIPTION OF THE DRAWINGS

The accompanying drawings, together with the specification, illustrate exemplary embodiments of the present invention, and, together with the description, serve to explain the principles of the disclosed technology.

FIG. 1 is a perspective view showing a case of a large-capacity battery, which has a valve for preventing backflow according to an embodiment of the disclosed technology.

FIG. 2 is an exploded perspective view of FIG. 1.

FIG. 3 is a schematic enlarged view showing the valve of FIG. 1.

### DETAILED DESCRIPTION OF CERTAIN INVENTIVE EMBODIMENTS

In the following detailed description, only certain exemplary embodiments of the disclosed technology have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. In addition, when an element is referred to as being “on” another element, it can be directly on the another element or be indirectly on the another element with one or more intervening elements interposed therebetween. Also, when an element is referred to as being “connected to” another element, it can be directly connected to the another element or be indirectly connected to the another element with one or more intervening elements interposed therebetween. Hereinafter, like reference numerals refer to like elements. In the drawings, the thickness or size of layers are exaggerated for clarity and not necessarily drawn to scale.

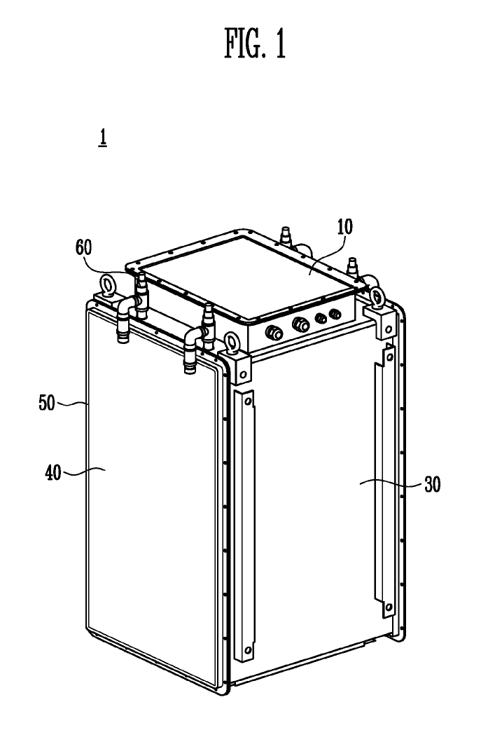

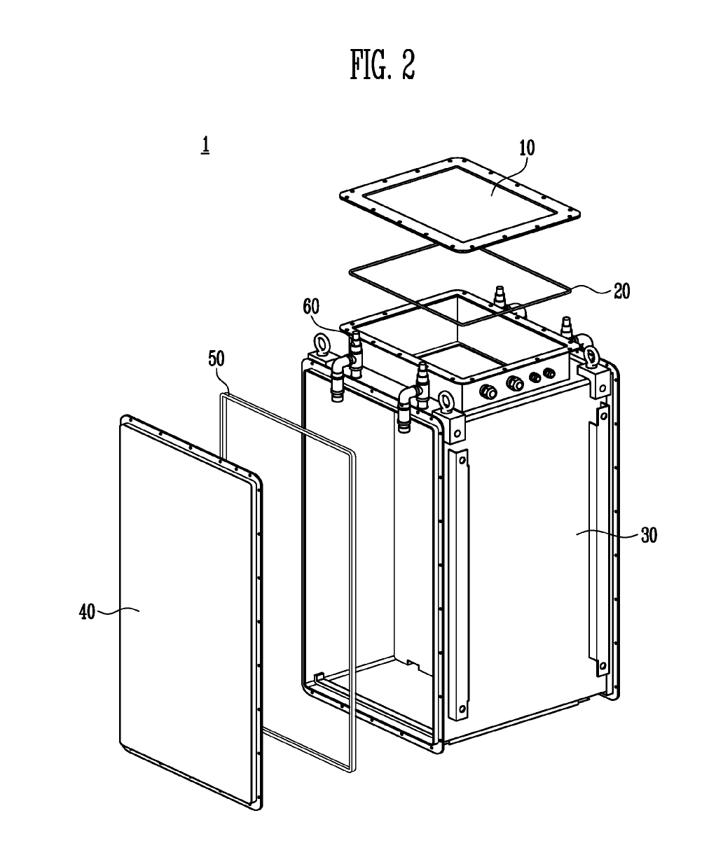

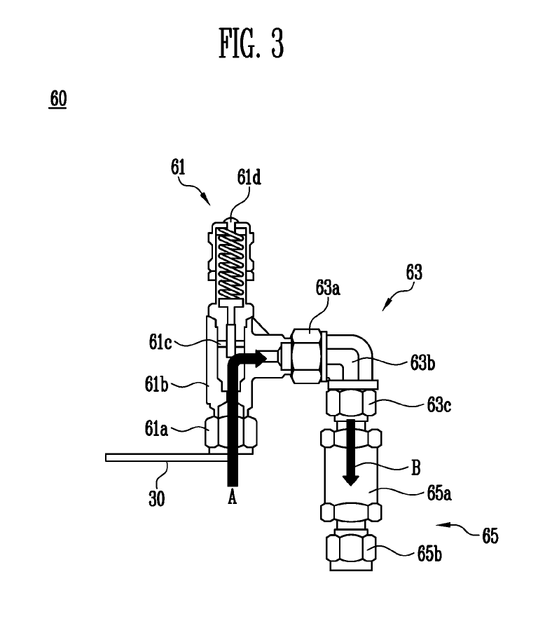

FIG. 1 is a perspective view showing a case of a large-capacity battery, which has a valve for preventing backflow according to an embodiment of the disclosed technology. FIG. 2 is an exploded perspective view of FIG. 1. FIG. 3 is a schematic enlarged view showing the valve of FIG. 1.

Referring to FIGS. 1 and 2, a case 1 of a large-capacity battery having a valve assembly 60 for preventing backflow according to various embodiments includes a case main body 30 accommodating a battery pack (not shown) therein, a door 40 that opens/closes to allow access to the case main body 30, a door sealing member 50 sealing the case main body 30 and the door 40, a top cover 10 fastened to the case main body 30, a top cover sealing member 20 forming a seal between the case main body 30 and the top cover 10, and the valve assembly 60 connected to the case main body 30 for use to discharge fluid from the case main body 30.

Here, the valve assembly 60 has a structure in which one end portion of the valve assembly 60 is connected to the case main body 30 and the other end portion of the valve assembly 60 opens to the outside of the case 1. Hereinafter, the valve assembly 60 according to this embodiment will be described in detail with reference to FIG. 3.

FIG. 3 is a schematic enlarged view showing the valve of FIG. 1.

Referring to FIG. 3, the valve assembly 60 according to various embodiments includes a first valve 61, a connection tube 63 connected to the first valve 61 and having at least one bent portion, and a second valve 65 connected to the connection tube 63. Here, the second valve 65 is disposed so that the lowermost surface of the second valve 65 is positioned lower than the lowermost surface of the first valve 61. Thus, the second valve 65 blocks the fluid advancing toward direction B via direction A from flowing backwards in the direction A.

The first valve 61 includes a first valve main body 61b, a coupling 61a provided at one end portion of the first valve main body 61b, an outlet 61d provided at the other end portion of the first valve main body 61b, and a sealing portion 61c provided between the coupling 61a and the outlet 61d.

Here, the coupling 61a is provided at the one end portion of the first valve main body 61b so as to be coupled to the case main body 30. The outlet 61d is provided at the other end portion having a direction opposite by 180 degrees to that of the coupling 61b provided at the one end portion of the first valve main body 61b so as to discharge a gas (first fluid) generated in a battery cell (not shown) in the fluid discharged from the case main body 30.

The first valve 61 has the sealing portion 61c therein. The sealing portion 61c is provided between the coupling 61a and the outlet 61d so as to form, in the direction A, the flow path of the other fluid (second fluid) except the gas (first fluid) discharged to the outlet 61d in the fluid discharged from the case main body 30. Here, the direction of the flow path of the other fluid is the direction of the connection tube 63 described later.

Here, the connection tube 63 includes a first fastener first fastener 63a, a connection tube main body 63b connected to the first fastener first fastener 63a, and a second fastener second fastener 63c. The first fastener first fastener 63a is coupled to the first valve 61, and the connection tube main body 63b is connected to the first fastener first fastener 63a, thereby forming a flow path of the fluid discharged from the first valve 61. The connection tube 63 has the second fastener second fastener 63c connecting the connection tube main body 63b to the second valve 65 described later.

The connection tube main body 63b has an elbow shape so as to form a predetermined angle with the first valve 61, thereby preventing backflow of the fluid. Although it has been described in this embodiment that the connection tube main body 63b has the elbow shape, the disclosed technology is not limited thereto. For example, the connection tube main body 63b may have various shapes including, for example, a “U” shape.

Meanwhile, the second valve 65 fastened to the connection tube 63 includes a second valve main body 65a and a check valve 65b. The second valve main body 65a is implemented so that one end portion of the second valve main body 65a is fastened to the second fastener second fastener 63c, and the check valve 65b is provided at the other end portion of the second valve main body 65a, which has a direction opposite by 180 degrees to that of the one end portion of the second valve main body 65a.

Here, the check valve 65b is opened to the outside so as to discharge the other fluid except the gas exhausted via the outlet 61d. The check valve 65b blocks the fluid from being again flowing backwards inside the case main body 30 by being forced backward in the direction of the connection tube 63. The check valve 65b is a valve having a structure that allows the fluid to pass only in one direction. Thus, the fluid discharged in the direction B does not flow backwards in the direction of the connection tube 63 but is discharged to outside the battery case.

Referring to FIGS. 2 and 3, the case 1 of the large-capacity battery is generally buried under the ground so as to constantly maintain pressure. In this case, the case 1 itself may be submerged in water and a gas may be generated from the battery cell accommodated in the case 1 as the temperature varies. Thus, it is important that the case 1 be watertight.

According to various embodiments, the lowermost surface of the second valve 65 that is the check valve opened to the outside is disposed lower than the lowermost surface of the first valve 61 connected to the case 1 so as to discharge the fluid from the case 1. Thus, it is possible to prevent the fluid discharged from the case 1 from being flowing backwards into the case 1.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A valve assembly for preventing backflow and use with a battery case, the valve assembly comprising:
a first valve;
a connection tube connected to the first valve and having at least one bent portion; and
a second valve connected to the connection tube,
wherein the second valve is disposed so that the lowermost surface of the second valve is positioned lower than the lowermost surface of the first valve so as to discharge fluid from a battery case.

2. The valve assembly of claim 1, wherein the first valve includes a first valve main body, a coupling provided at one end portion of the first valve main body so as to be coupled to a main body of the battery case, and an outlet provided at the other end portion having a direction opposite to that of the one end portion so as to discharge a first fluid from the main body.

3. The valve assembly of claim 2, wherein the first valve has a sealing portion between the coupling and the outlet, and forms a flow path of a second fluid that is another fluid in the fluid discharged from the case main body.

4. The valve assembly of claim 3, wherein the connection tube includes a first fastener coupled to the first valve, a connection tube main body connected to the first fastener so as to form the flow path of the second fluid, and a second fastener connecting the connection tube main body and the second valve.

5. The valve assembly of claim 4, wherein the connection tube main body has an elbow or “U” shape forming a predetermined angle with the first valve.

6. The valve assembly of claim 4, wherein the second valve includes a second valve main body having one end portion fastened to the second fastener, and a check valve provided at the other end portion of the second valve main body, which has a direction opposite to that of the one end portion.

7. The valve assembly of claim 6, wherein the check valve is opened to the outside of the battery case so as to block the second fluid from flowing backwards in the direction of the connection tube.

8. A battery case, comprising:
a main body accommodating a battery pack therein; and
a valve assembly for preventing backflow, connected to the main body so as to discharge a fluid from the main body,
wherein the valve assembly comprises:
a first valve;
a connection tube connected to the first valve and having at least one bent portion; and
a second valve connected to the connection tube,
wherein the second valve is disposed so that the lowermost surface of the second valve is positioned lower than the lowermost surface of the first valve.

9. The battery case of claim 8, wherein the first valve includes a first valve main body, a coupling provided at one end portion of the first valve main body so as to be coupled to the case main body, and an outlet provided at the other end portion having a direction opposite to that of the one end portion so as to discharge a first fluid from the battery case.

10. The battery case of claim 9, wherein the first valve has a sealing portion between the coupling and the outlet, and forms a flow path of a second fluid that is another fluid in the fluid discharged from the case main body.

11. The battery case of claim 10, wherein the connection tube includes a first fastener coupled to the first valve, a connection tube main body connected to the first fastener so as to form the flow path of the second fluid, and a second fastener connecting the connection tube main body and the second valve.

12. The battery case of claim 11, wherein the connection tube main body has an elbow or “U” shape forming a predetermined angle with the first valve.

13. The battery case of claim 11, wherein the second valve includes a second valve main body having one end portion fastened to the second fastener, and a check valve provided at the other end portion of the second valve main body, which has a direction opposite to that of the one end portion.

14. The battery case of claim 13, wherein the check valve opens to the outside of the battery case so as to block the second fluid from flowing backwards in the direction of the connection tube.

15. The battery case of claim 8, further comprising:
a door that opens/closes mounted on the main body; and
a door sealing member forming a seal between the main body and the door.

16. The battery case of claim 8, further comprising:
a top cover fastened to the case main body; and
a top cover sealing member forming a seal between the main body and the top cover.
